(19) United States
(12) Patent Application Publication
(10) Pub. No.: US 2014/0195912 A1
(43) Pub. Date: Jul. 10, 2014

(54) METHOD AND SYSTEM FOR SIMULTANEOUS DISPLAY OF VIDEO CONTENT

(71) Applicant: NVIDIA Corporation, Santa Clara, CA (US)

(72) Inventors: Aleksandar ODOROVIC, Santa Clara, CA (US); Alok AHUJA, San Jose, CA (US); Andrija BOSNJAKOVIC, Santa Clara, CA (US)

(73) Assignee: NVIDIA Corporation, Santa Clara, CA (US)

(21) Appl. No.: 14/055,648

(22) Filed: Oct. 16, 2013

Related U.S. Application Data
(60) Provisional application No. 61/749,231, filed on Jan. 4, 2013.
(60) Provisional application No. 61/749,224, filed on Jan. 4, 2013.
(60) Provisional application No. 61/749,233, filed on Jan. 4, 2013.

(51) Int. Cl. G06F 3/0484

(52) U.S. Cl. CPC G06F 3/0484
USPC 715/719

(57) ABSTRACT

An apparatus including: a receiving module operable to receive video content through a communication network simultaneously from a set of devices; a decoding module operable to decode the received video content from the set of devices into decoded video content; an arranging module operable to combine and arrange the decoded video content into a single video; and a displaying module operable to provide the single video for display on a display device.

### CROSS-REFERENCE TO RELATED APPLICATIONS

This application claims priority from U.S. Provisional Application No. 61/749,231, “HANDHELD GAMING CONSOLE,” Attorney Docket NVID P-SC-12-0470-US0, filed Jan. 4, 2013, the entire disclosure of which is incorporated herein by reference. This application claims priority from U.S. Provisional Application No. 61/749,224, “NETWORK-ATTACHED GPU DEVICE,” Attorney Docket NVID P-SC-12-0814-US0, filed Jan. 4, 2013, the entire disclosure of which is incorporated herein by reference. This application claims priority from U.S. Provisional Application No. 61/749,233, “STREAMING FOR PORTABLE GAMING DEVICE,” Attorney Docket NVID P-SC-12-0862-US0, filed Jan. 4, 2013, the entire disclosure of which is incorporated herein by reference.

### BACKGROUND OF THE INVENTION

Historically, an application such as a video game was executed (played) using a personal computer (PC) or using a console attached to a television. A user purchased or rented a game, which was loaded onto the PC or inserted into the game console and then played in a well-known manner.

More recently, online gaming has become popular. An online game is played over a network, such as the Internet. The game is loaded onto a user's device while other software needed to play the game may reside on a server that is accessed via the network. Online or network gaming allows multiple users to compete against each other in the game environment provided by the software on the server. Further, multiple gaming devices and/or multiple displays may be used during gaming sessions.

In many instances, multiple users may be engaged with each other in a multiplayer game, with instances of the multiplayer game running on each user's mobile device. The multiple users may be in the vicinity of a television device or other display device that is typically larger than the internal display of the users' mobile devices. Accordingly, a need exists to take advantage of such external display devices.

### BRIEF SUMMARY OF THE INVENTION

Accordingly, one or more embodiments of the invention are directed to methods and systems for simultaneously displaying video content from multiple devices.

In some embodiments, an apparatus includes a receiving module operable to receive video content through a network simultaneously from a plurality of devices. The apparatus further includes a decoding module operable to decode the received video content from the plurality of devices. The apparatus also includes an arranging module operable to combine and arrange the decoded video content received from the plurality of devices into a single common or combined video. The apparatus additionally includes a displaying module operable to provide the common or combined single video for display on a display device.

In some embodiments, the arranging module is further operable to combine and arrange the video content received from the plurality of devices within a plurality of equally-sized areas within the common or combined single video. In some embodiments, each of the equally-sized areas within the common or combined single video is associated with the received video content from each of the plurality of devices. In some embodiments, the displaying module is further operable to simultaneously display a subset of the video content within the display. In some embodiments, the video content comprises content associated with a multiplayer game. In some embodiments, the content associated with the multiplayer game comprises at least one of a scoreboard, a map or a spectator view of the multiplayer game. In some embodiments, the apparatus also includes an application module operable to provide an application programming interface (API) wherein the video content is based at least in part on programmable parameters of the API.

In some embodiments, a method includes receiving video content through a network simultaneously from a plurality of devices. The method further includes decoding the received video content from the plurality of devices, resulting in decoded video content. The method also includes combining and arranging the decoded video content into a common or combined single video. The method additionally includes providing the common or combined single video for display on a display device.

A non-transitory computer readable medium including a set of instructions configured to execute on at least one computer processor to enable the computer processor to receive video content through a network simultaneously from a set of devices. The set of instructions further include functionality to decode the received video content from the set of devices into decoded video content; combine and arranging the decoded video content into a single video; and provide the single video for display on a display device.

The following detailed description together with the accompanying drawings will provide a better understanding of the nature and advantages of the present invention.

### BRIEF DESCRIPTION OF THE DRAWINGS

Embodiments of the present invention are illustrated by way of example, and not by way of limitation, in the figures of the accompanying drawings and in which like reference numerals refer to similar elements.

FIG. 1 is a block diagram of an example of a computer system capable of implementing embodiments according to the present invention.

FIG. 2 is a block diagram of an example of a client device capable of implementing embodiments according to the present invention.

FIG. 3 is a block diagram of an example of a network architecture in which client systems and servers may be coupled to a network, according to embodiments of the present invention.

FIG. 4 is a block diagram of an exemplary video arrangement device, according to embodiments of the present invention.

FIG. 5A depicts a video arrangement device combining and arranging content from a plurality of devices into a dual split-screen format on a display, according to embodiments of the present invention.

FIG. 5B depicts a video arrangement device combining and arranging content from a plurality of devices into a quad split-screen format on a display, according to embodiments of the present invention.

FIG. 6A depicts a video arrangement device displaying a map for a game (e.g. a multiplayer game) on a display, according to embodiments of the present invention.

FIG. 6B depicts a video arrangement device displaying a scoreboard for a multiplayer game on a display, according to embodiments of the present invention.

FIG. 7A is a block diagram of one or more handheld gaming consoles communicatively coupled with a display, according to embodiments of the present invention.

FIG. 7B is a block diagram of a handheld gaming console communicatively coupled with a display, according to embodiments of the present invention.

FIG. 8 is a block diagram of one or more handheld gaming consoles communicatively coupled with a locally-based server, according to embodiments of the present invention.

FIG. 9 is a block diagram of a handheld gaming console communicatively coupled with a cloud-based server, according to embodiments of the present invention.

FIG. 10 is a block diagram of the handheld gaming console communicatively coupled with the cloud-based server that is in turn communicatively coupled with a set-top box (STB), according to embodiments of the present invention.

FIG. 11 is a block diagram of a handheld gaming console communicatively coupled with the external display, app store or, locally-based server, cloud-based server, STB, according to embodiments of the present invention.

FIG. 12 depicts a flowchart of an exemplary computer-implemented process of simultaneously displaying video content according to an embodiment of the present invention.

### DETAILED DESCRIPTION OF THE INVENTION

Reference will now be made in detail to the various embodiments of the present disclosure, examples of which are illustrated in the accompanying drawings. While described in conjunction with these embodiments, it will be understood that they are not intended to limit the disclosure to these embodiments. On the contrary, the disclosure is intended to cover alternatives, modifications and equivalents, which may be included within the spirit and scope of the disclosure as defined by the appended claims. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure.

Some portions of the detailed descriptions that follow are presented in terms of procedures, logic blocks, processing, and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those utilizing physical manipulations of physical quantities. Usually, although not necessarily, these quantities take the form of electrical or magnetic signals capable of being stored, transferred, combined, compared, and otherwise manipulated in a computer system. It has proven convenient at times, principally for reasons of common usage, to refer to these signals as transactions, bits, values, elements, symbols, characters, samples, pixels, or the like.

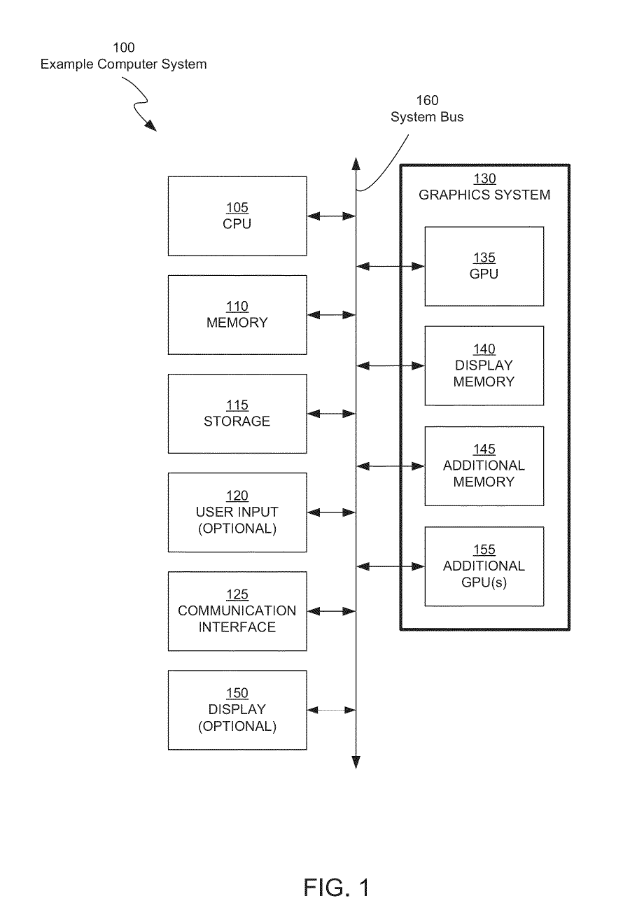

It should be borne in mind, however, that all of these and similar terms are to be associated with the appropriate physical quantities and are merely convenient labels applied to these quantities. Unless specifically stated otherwise as apparent from the following discussions, it is appreciated that throughout the present disclosure, discussions utilizing terms such as “receiving,” “generating,” “sending,” “decoding,” “encoding,” “accessing,” “streaming,” or the like, refer to actions and processes of a computer system or similar electronic computing device or processor (e.g., system 100 of FIG. 1). The computer system or similar electronic computing device manipulates and transforms data represented as physical (electronic) quantities within the computer system memories, registers or other such information storage, transmission or display devices.

Embodiments described herein may be discussed in the general context of computer-executable instructions residing on some form of computer-readable storage medium, such as program modules, executed by one or more computers or other devices. By way of example, and not limitation, computer-readable storage media may comprise non-transitory computer-readable storage media and communication media; non-transitory computer-readable media include all computer-readable media except for a transitory, propagating signal. Generally, program modules include routines, programs, objects, components, data structures, etc., that perform particular tasks or implement particular abstract data types. The functionality of the program modules may be combined or distributed as desired in various embodiments.

Computer storage media includes volatile and nonvolatile, removable and non-removable media implemented in any method or technology for storage of information such as computer-readable instructions, data structures, program modules or other data. Computer storage media includes, but is not limited to, random access memory (RAM), read only memory (ROM), electrically erasable programmable ROM (EEPROM), flash memory or other memory technology, compact disk ROM (CD-ROM), digital versatile disks (DVDs) or other optical storage, magnetic cassettes, magnetic tape, magnetic disk storage or other magnetic storage devices, or any other medium that can be used to store the desired information and that can be accessed to retrieve that information.

Communication media can embody computer-executable instructions, data structures, and program modules, and includes any information delivery media. By way of example, and not limitation, communication media includes wired media such as a wired network or direct-wired connection, and wireless media such as acoustic, radio frequency (RF), infrared, and other wireless media. Combinations of any of the above can also be included within the scope of computer-readable media.

FIG. 1 is a block diagram of an example of a computer system 100 capable of implementing embodiments according to the present invention. In the example of FIG. 1, the computer system 100 includes a central processing unit (CPU) 105 for running an operating system, wherein the operating system may run software applications. Memory 110 stores applications and data for use by the CPU 105. Storage 115 provides non-volatile storage for applications and data and may include fixed disk drives, removable disk drives, flash memory devices, and CD-ROM, DVD-ROM or other optical storage devices. The optional user input 120 includes devices that communicate user inputs from one or more users to the computer system 100 and may include keyboards, mice, joysticks, touch screens, and/or microphones.

The communication or network interface 125 allows the computer system 100 to communicate with other computer systems via an electronic communications network, including wired and/or wireless communication and including the Internet. The optional display device 150 may be any device capable of displaying visual information in response to a signal from the computer system 100. The components of the computer system 100, including the CPU 105, memory 110, data storage 115, user input devices 120, communication interface 125, and the display device 150, may be coupled via one or more system buses 160. System buses 160 may be or may include data buses, control buses, address buses, and/or any other internal buses.

In the embodiment of FIG. 1, a graphics system 130 may be coupled with the system bus 160 and the components of the computer system 100. The graphics system 130 may include a physical graphics processing unit (GPU) 135 and graphics memory. The GPU 135 generates pixel data for output images from rendering commands. The physical GPU 135 can be configured as multiple virtual GPUs that may be used in parallel (concurrently) by a number of applications executing in parallel.

Graphics memory may include a display memory 140 (e.g., a framebuffer) used for storing pixel data for each pixel of an output image. In another embodiment, the display memory 140 and/or additional memory 145 may be part of the memory 110 and may be shared with the CPU 105. Alternatively, the display memory 140 and/or additional memory 145 can be one or more separate memories provided for the exclusive use of the graphics system 130.

In another embodiment, graphics processing system 130 includes one or more additional physical GPUs 155, similar to the GPU 135. Each additional GPU 155 may be adapted to operate in parallel with the GPU 135. Each additional GPU 155 generates pixel data for output images from rendering commands. Each additional physical GPU 155 can be configured as multiple virtual GPUs that may be used in parallel (concurrently) by a number of applications executing in parallel. Each additional GPU 155 can operate in conjunction with the GPU 135 to simultaneously generate pixel data for different portions of an output image, or to simultaneously generate pixel data for different output images.

Each additional GPU 155 can be located on the same circuit board as the GPU 135, sharing a connection with the GPU 135 to the system bus 160, or each additional GPU 155 can be located on another circuit board separately coupled with the system bus 160. Each additional GPU 155 can also be integrated into the same module or chip package as the GPU 135. Each additional GPU 155 can have additional memory, similar to the display memory 140 and additional memory 145, or can share the memories 140 and 145 with the GPU 135.

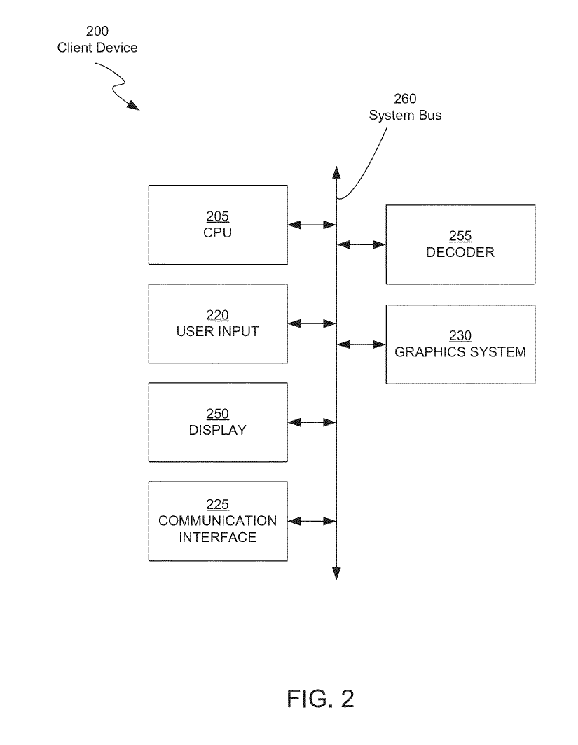

FIG. 2 is a block diagram of an example of an end user or client device 200 capable of implementing embodiments according to the present invention. In the example of FIG. 2, the client device 200 includes a CPU 205 for running an operating system, wherein the operating system may run software applications. The user input 220 includes devices that communicate user inputs from one or more users and may include keyboards, mice, joysticks, touch screens, and/or microphones.

The communication interface 225 allows the client device 200 to communicate with other computer systems (e.g., the computer system 100 of FIG. 1) via an electronic communications network, including wired and/or wireless communication and including the Internet. The decoder 255 may be any device capable of decoding (decompressing) video data that may be encoded (compressed). For example, the decoder 255 may be an H.264 decoder. The display device 250 may be any device capable of displaying visual information, including information received from the decoder 255. The display device 250 may be used to display visual information generated at least in part by the client device 200. However, the display device 250 may be used to display visual information received from the computer system 100. The components of the client device 200 may be coupled via one or more system buses 260. Further, the components may or may not be physically included inside the housing of the client device 200. For example, the display 250 may be a monitor that the client device 200 communicates with either through cable or wirelessly.

Relative to the computer system 100, the client device 200 in the example of FIG. 2 may have fewer components and less functionality and, as such, may be referred to as a thin client. However, the client device 200 may include other components including all those described above with regard to the computer system 100, for example, graphics system 230 that may be similar to graphics system 130 of FIG. 1. In general, the client device 200 may be any type of device that has display capability, the capability to decode (decompress) data, and the capability to receive inputs from a user and send such inputs to the computer system 100. However, the client device 200 may have additional capabilities beyond those just mentioned. The client device 200 may be, for example, a personal computer, a tablet computer, a television, a hand-held gaming system, or the like.

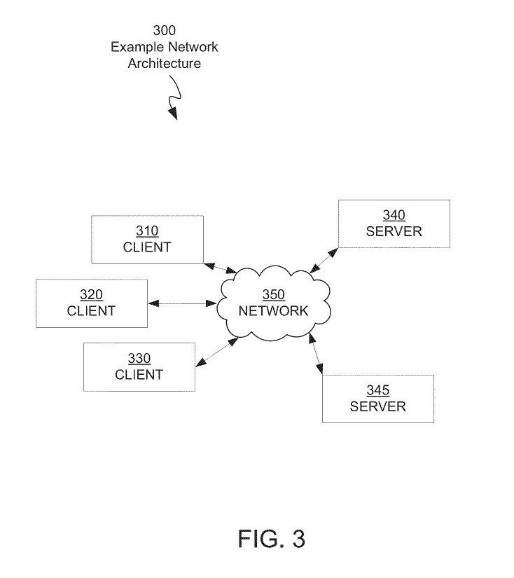

FIG. 3 is a block diagram of an example of a network architecture 300 in which client systems 310, 320, and 330 and servers 340 and 345 may be coupled to a network 350. Client systems 310, 320, and 330 generally represent any type or form of computing device or system, such as the computing system 100 of FIG. 1 or the client device 200 of FIG. 2.

Similarly, servers 340 and 345 generally represent computing devices or systems, such as application servers, configured to provide various services and/or run certain software applications. Network 350 generally represents any telecommunication or computer network including, for example, an intranet, a wide area network (WAN), a local area network (LAN), a personal area network (PAN), or the Internet.

With reference to computing system 100 of FIG. 1, a communication interface, such as communication interface 125, may be used to provide connectivity between each client system 310, 320, and 330 and network 350. Client systems 310, 320, and 330 may be able to access information on server 340 or 345 using, for example, a Web browser or other client software. Such software may allow client systems 310, 320, and 330 to access data hosted by server 340 or server 345. Although FIG. 3 depicts the use of a network (such as the Internet) for exchanging data, the embodiments described herein are not limited to the Internet or any particular network-based environment.

In one embodiment, all or a portion of one or more of the example embodiments disclosed herein are encoded as a computer program and loaded onto and executed by server 340 or server 345, or any combination thereof. All or a portion of one or more of the example embodiments disclosed herein may also be encoded as a computer program, stored in server 340, run by server 345, and distributed to client systems 310, 320, and 330 over network 350.

Method and System for Simultaneous Display of Video Content

Embodiments of the present invention provide methods and systems for simultaneous display of video content, for example, the simultaneous display of multiplayer gaming content. However, embodiments of the present invention can be applied to simultaneous display of any type of content.

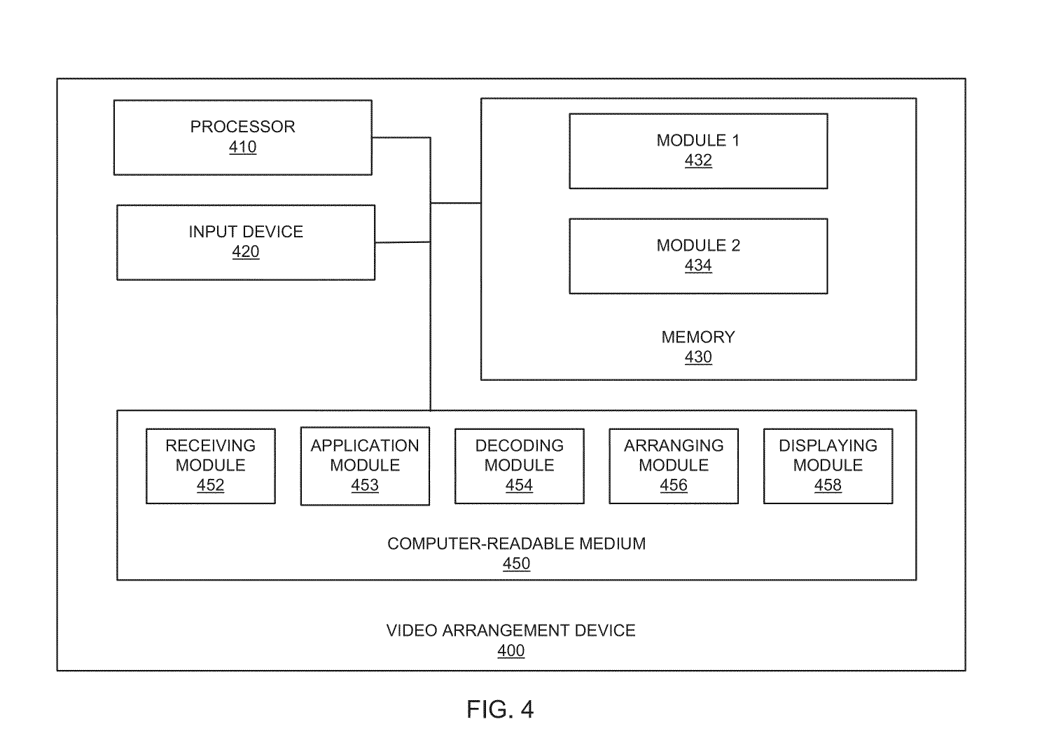

FIG. 4 is a block diagram of a video arrangement device 400, according to embodiments of the present invention. Video arrangement device 400 includes a processor 410, input device 420, memory 430, and computer-readable medium 450.

Processor 410 may be any general-purpose processor operable to carry out instructions on the video arrangement device 400. The processor 410 is coupled to other units of the video arrangement device 400 including input device 420, memory 430, and computer-readable medium 450.

Input device 420 may be any device that accepts input from a user. Examples may include a keyboard, keypad, mouse, etc. In some embodiments, a multi-touch pad may be an input device.

Memory 430 may be any magnetic, electronic, or optical memory. Memory 430 includes two memory modules, module 1 432 and module 2 434. It can be appreciated that memory 430 may include any number of memory modules. An example of memory 430 may be dynamic random access memory (DRAM).

Computer-readable medium 450 may be any magnetic, electronic, optical, or other computer-readable storage medium. Computer-readable storage medium 450 includes receiving module 452, application module 453, decoding module 454, arranging module 456, and displaying module 458. Computer-readable storage medium 450 may comprise any combination of volatile and/or non-volatile memory such as, for example, buffer memory, RAM, DRAM, ROM, flash, or any other suitable memory device, alone or in combination with other data storage devices.

Receiving module 452 is configured to receive video content through a network simultaneously from a plurality of devices. In some embodiments, the network may be the network 350 of FIG. 3. In some embodiments, the plurality of devices may be a plurality of handheld multiplayer gaming devices. For example, receiving module 452 may receive gaming content from a plurality of handheld multiplayer gaming devices. The gaming content may include video content of the multiplayer game. The video content may be received by the receiving module via wireless or wired standard, e.g., Wi-Fi or Ethernet.

Decoding module 454 is configured to decode the received video content from the plurality of devices. In some embodiments, the video content received by receiving module 452 may be in an encoded format, e.g., H.264. Decoding module 454 may decode the encoded video content into a format suitable for display on an attached display device (not shown).

Arranging module 456 may be configured to combine and arrange the decoded video content received from the plurality of video streams from one or more devices into a single video, e.g. a combined or common video. Arranging module 456 may arrange and combine the received and decoded video content for display on an attached display device (not shown). The combining and arranging may be done in any fashion and may be based at least in part on the number of devices. For example, if receiving module 452 receives video content from two separate devices, arranging module 456 may arrange video content from one of the devices on a left hand portion of a display and video content from the other device on a right hand portion of a display. Similarly, arranging module 456 may arrange video content from one of the devices on a top portion of a display and video content from the other device on a bottom portion of a display. Arranging module 456 may then, upon the arranging, combine the video content into a single seamless video stream.

In some embodiments, arranging module 456 may display a subset of the received video content. For example, if receiving module 452 receives video content related to a multiplayer game, displaying module 452 may display a map associated with a multiplayer game running on the communicatively coupled gaming device while a built-in display of the device may continue to display a first person perspective of the multiplayer game. In some embodiments, arranging module 456 may extract the subset (e.g., video content representing a map in the game) from the received video content.

Displaying module 458 is configured to provide the single video for display on a display device (not shown). Displaying module may be coupled to an output module (not shown) within video arrangement device 400, e.g., an HDMI port. Displaying module may be operable to display the single video in any format, e.g., NTSC, PAL, etc.

Application module 453 is configured to provide an application programming interface (API). The API may be used by a game developer or an application developer to define the video content that may be arranged and combined by arranging module 456 and displayed by displaying module 458. The API may provide a render target for a game developer to render specific drawings within a multiplayer game, e.g. scenery, objects, etc. The API may also allow a game developer to define an alternate display to display gaming content during execution of the multiplayer game. Similarly, the API may allow for multiple render targets or alternate displays for related content in a professional application.

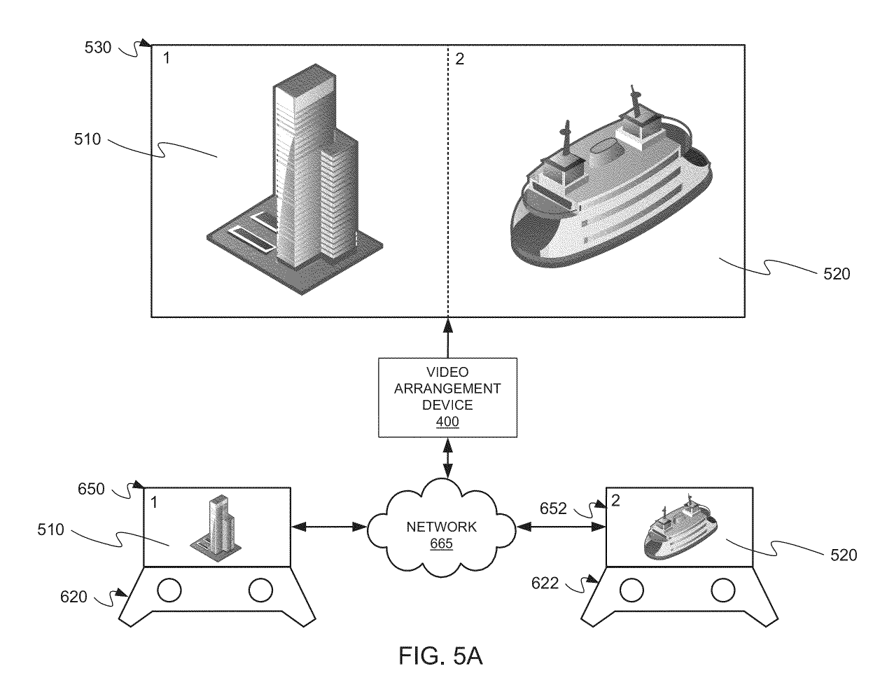

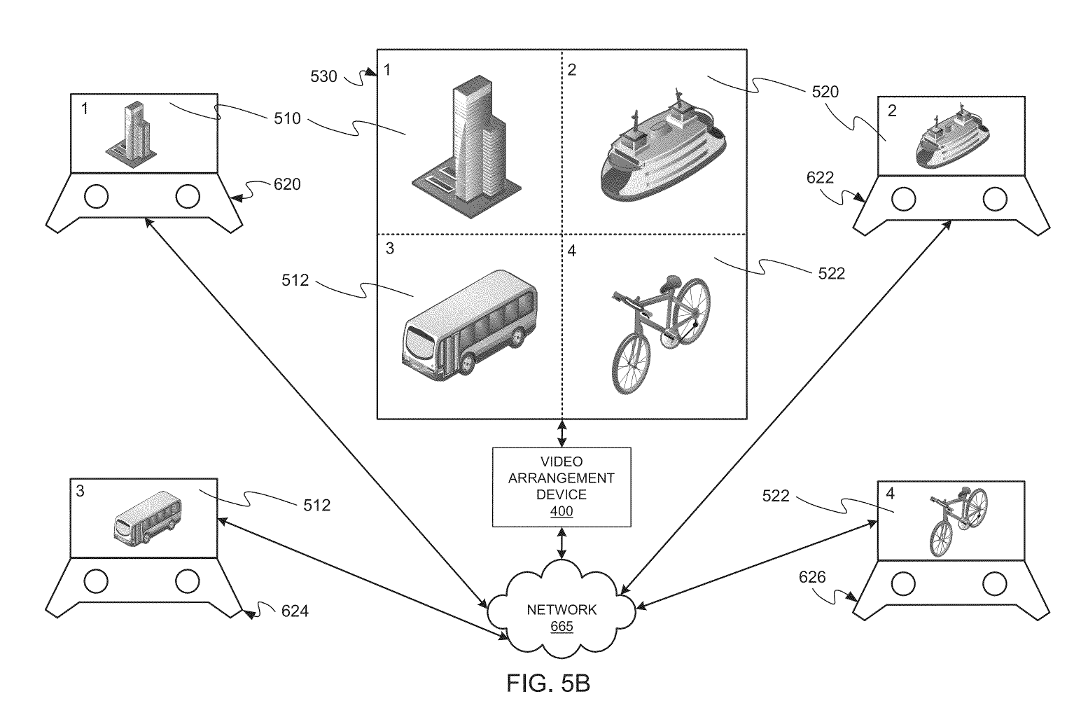

FIG. 5A depicts a video arrangement device 400 combining and arranging video content 510 and 520 from corresponding devices (e.g., 620 and 622) into a dual split-screen format on a display 530, according to embodiments of the present invention. The plurality of devices may include a first device 620 and a second device 622. In some embodiments, the first device 620 and a second device 622 may be handheld gaming devices. First device 620 may include a first display 650 operable to display a first video content 510. Second device 622 may include second display 652 operable to display a second video content 520. First device 620 and second device 622 may be connected to video arrangement device 400 via a network 665. In some embodiments, the network 665 between the plurality of devices 620 and 622 and video arrangement device 400 may be a wired or wireless network employing any standard.

As described above, video arrangement device 400 may be configured to simultaneously display video content 510 and 520, for example, the simultaneous display of multiplayer gaming content. Video arrangement device 400 may receive video content 510 and 520 from a plurality of devices 620 and 622 via a communication link over network 665. The video arrangement device 400 may be connected to a display device 530. In some embodiments, the display device 530 may be a television. The connection between video arrangement device 400 and display device 530 may be any connection defined by an audio/video protocol including, but not limited to, HDMI, DisplayPort, VGA, etc.

In some embodiments, first device 620 and second device 622 may be operated by a first user and second user respectively. The first user and the second user may be engaging in a multiplayer game on the first device 620 and the second device 622. In some embodiments, the video arrangement device 400 may allow for the mirroring of first video content 510 and second video content 520 to a larger display 530 for improved user experience in the multiplayer game. The video arrangement device 400 may receive first video content 510 and second video content 520 from the first device 620 and the second device 622 via network 665. Video arrangement device 400 may decode the received first video content 510 and second video content 520, if the received video content is in an encoded format. Video arrangement device 400 may then combine and arrange the received first video content 510 and second video content 520 into a single video for display on the display device 530. The single video may then be displayed on display device 530.

The arranging and combining of the received video content may be done in any manner for optimal presentation to the users. In some embodiments, the received video content is arranged in a split screen format. For example, the received video content may be displayed side-by-side in the single video or may be displayed top-to-bottom in the single video, or may be displayed picture-in-picture.

In some embodiments, the combining and arranging of the received video content may be done based on which device the video content was received from. For example, first video content 510 from first device 620 may be displayed on the left hand side of the screen and second video content 520 from second device 622 may be displayed on the right hand side of the screen. The dotted vertical line in FIG. 5A represents the split location of first video content 510 and second video content 520 for demonstration purposes only and may not be included in the actual arranged video.

In some embodiments, the multiplayer game running on the first device 620 and/or the second device 622 may reside within a cloud server. The cloud server may stream the gaming content to the first device 620 and/or the second device 622. In some embodiments, the cloud server may stream the gaming content directly to video arrangement device 400 for display on display device 530 while first device 620 and second device 622 may be used as input devices for the multiplayer game.

In some embodiments, the first device 620 may function as a “master” device operable to receive video content from second device 622 and combine and arrange video content into a single video. The single video may be sent from the first device 620 to the video arrangement module 400. The video arrangement module 400 may then display the single video on display device 530.

It can be appreciated that while FIG. 5A depicts two devices, any number of devices may be present.

FIG. 5B depicts a video arrangement device 400 combining and arranging content from one or more devices into a quad split-screen format on a display, according to embodiments of the present invention. FIG. 5B is similar to FIG. 4A except that four devices are present: first device 620, second device 622, third device 624, and fourth device 626. As described above, each device may send video content to the video arrangement device 400. In this example, first video content 510, second video content 520, third video content 512, and fourth video content 522 are sent to video arrangement device 400 via network 665. The video content may be combined and arranged into a single video by video arrangement device 400, as described above. The single video may be displayed on display device 530.

In some embodiments, the separate video content may be displayed in each quadrant of display device 530. In other embodiments, the separate video content may be arranged in a side-by-side fashion or a top-to-bottom fashion. It can be appreciated that the separate video content may be, but is not required to be, equally-sized in each quadrant of display device 530. The dotted lines in FIG. 5B represent the split location of different video content for demonstration purposes only and may not be included in the actual video.

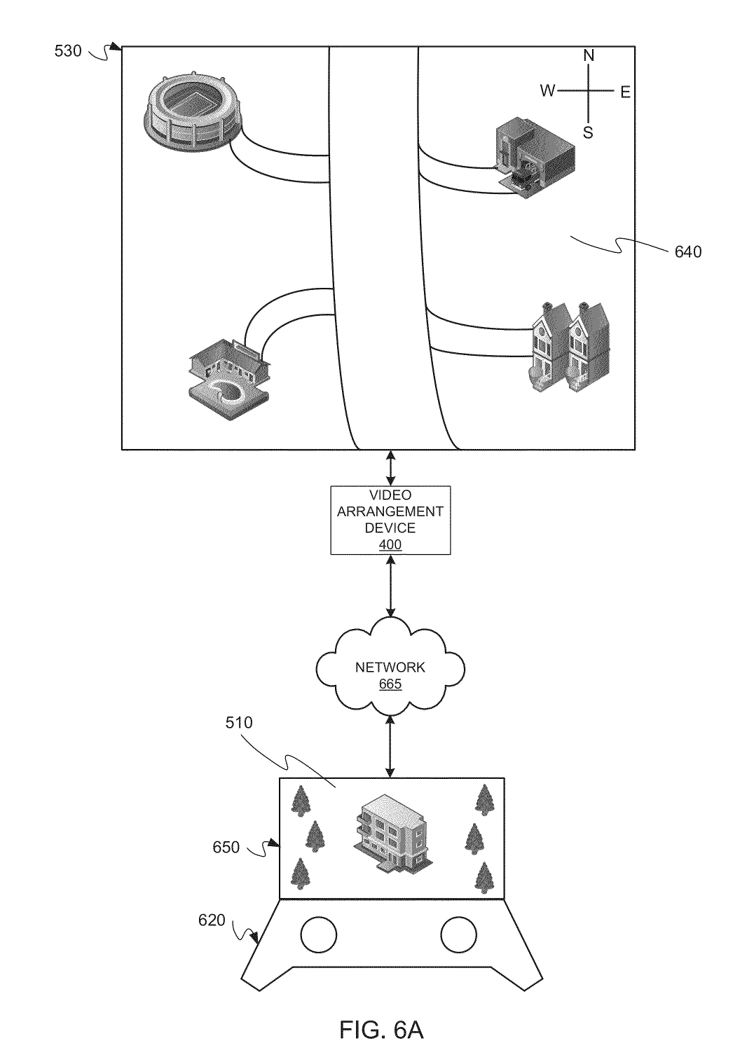

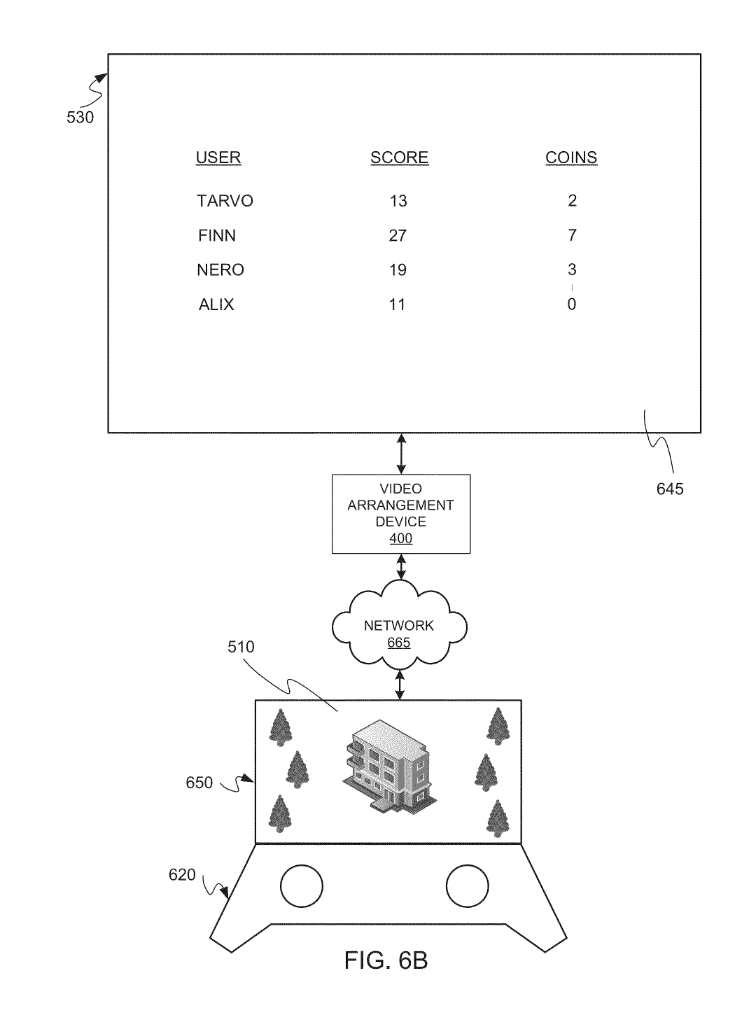

FIG. 6A depicts a video arrangement device 400 displaying a map for a game (e.g. a multiplayer game) on a display 530, according to embodiments of the present invention. In some embodiments, the video arrangement device 400 may receive video content 510 from a first device 620 and arrange only a subset of the received video content 510 for display on display device 530. First device 620 may send video content 510 to video arrangement device 400, other than what is displayed on first display 650 of first device 620. In the example of a game, first device 620 may send all gaming content to video arrangement device 400, via network 665. The video arrangement device 400 may then select a subset of the received gaming content to display on display device 530 while the first display 650 of first device 620 may display gaming content other than the selected subset.

For example, in FIG. 6A, the first display 650 of first device 620 may display video content 510 of a first person view within a game. The first device 620 may send all gaming content to video arrangement device 400 via network 665, and video arrangement device 400 may select a map view 640 of the game from the received gaming content. Video arrangement device 400 may display the map view 640 of the multiplayer game on display device 530. The user may experience the benefit of being able to view gaming content on two separate displays. In some embodiments, the first device 620 may only send a subset of the gaming content to the video arrangement device 400 and video arrangement device 400 may display the received subset on display 530. For example, first device 620 may only send the map view 640 to the video arrangement device 400.

In some embodiments, the subset of video content displayed on display device 530 may be predefined by an API. For example, in a multiplayer game developer may define display device 530 to be used for displaying a map view 640 for the multiplayer game. In this scenario, the video arrangement device 400 may select the subset of video content based on predefined parameters within the API.

In some embodiments, the display device 530 may display a spectator view of a multiplayer game. From the received video content, the video arrangement device 400 may select a subset of video content that is a spectator view of the multiplayer gaming environment. For example, first device 620 may display a first-person view within the multiplayer gaming environment while the display device 530 may display a third-person view within the multiplayer gaming environment.

In one or more embodiments, the first device 620 may send game data besides video to the video arrangement device 400 and the video arrangement device 400 may generate video to be displayed by the display device 530 based on the received game data. For example, the first device 620 may send game data representing a position of a player's character within a map and other data that may be used to generate a map, and the video arrangement device 400 may then generate a map view that indicates the player's character's position. Alternatively, the video arrangement device 400 may generate a spectator view based on the received game data.

FIG. 6B depicts a video arrangement device 400 displaying a scoreboard 645 for a multiplayer game on a display 530, according to embodiments of the present invention. As described above, the video arrangement device 400 may select a subset of received video content from the first device 620 for display on display device 530. In some embodiments, the video arrangement device 400 may display a subset of received video content based on predefined parameters within an API.

The received video content may include a scoreboard 645 for a multiplayer game. The scoreboard 645 may indicate a current score for players within the multiplayer game. The players and their respective devices for the multiplayer game may all reside within the same network 665 or may reside within other networks as the multiplayer game is played over the Internet.

It should be appreciated that video arrangement device 400 may receive video or game data from additional devices like second device 622 of FIGS. 5A and 5B and thereby generate video depicting a map, spectator view, or any other content based at least in part on such video or game data. It should also be appreciated that video arrangement device 400 may generate split screen video that includes various portions including portions depicting game play, a map view, a spectator view, a statistics or score view, and/or any other content simultaneously side by side. For example, a first quadrant portion may depict game play, a second quadrant portion may depict a map view, a third quadrant may depict a statistics or score view, and a fourth quadrant may depict a spectator view.

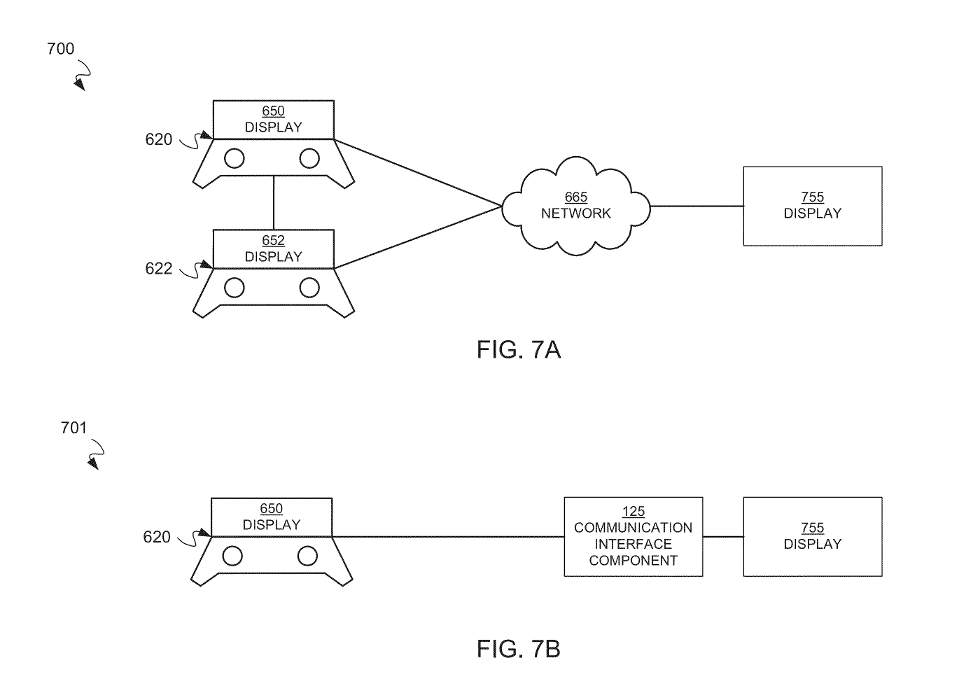

FIG. 7A is a block diagram 700 of one or more handheld gaming consoles 620 and 622 communicatively coupled with a display 755, according to embodiments of the present invention. The handheld gaming console 620 of FIG. 7A may be the same as or similar to devices 620, 622, 624, and 626 of FIGS. 5A through 6B. For example, the gaming console 620 may include a display 650 similar to the console display 650 of FIG. 5A.

The gaming console 620 may be communicatively coupled with the display 755 through a network 665, for example, through wired or wireless interfaces. The network 665 may be similar to the network 350 of FIG. 3 and may include local area network (LAN) and/or wide area network (WAN) portions.

The display 755 may be any display, for example, a large display like a flat panel HDTV. The gaming console 620 may transmit images, video, audio, and other data to the display 755 through the network 665. The display 755 may then be able to display the video, play back the audio. Further, the display 755 may make use of the transmitted data. For example, the data may include instructions to the display 755 to change to different audio or video modes, or to change arranging scheme of arranged video content.

In various embodiments, the gaming console 620 may execute a video game using components discussed above with reference to FIGS. 1 through 6B, like a processor, graphics processing system, memory, and so on. The gaming console 620 may send video and audio related to the video game to the display 755, which in turn may display the content. As a result, the display may show the output of a video game played on the gaming console 620.

While the display 755 shows and plays the video game content, the display 650 of the gaming console 620 may not display any content at all or any content related to the video game. Alternatively, the display 650 may show content related to the video game different from what is shown by the display 755. For example, the display 650 may show statistics related to game play, taunts from other players, hints related to game play, and so on. For example, the display 755 may show a cockpit view of a driving game while the display 650 shows a rear view mirror view.

More than one gaming console may be communicatively coupled with the display 755. As illustrated in FIG. 7A, a second gaming console 622 may be coupled with the display 755 through the network 665. One of the gaming consoles may be a master console while the others are slave consoles. Accordingly, both gaming consoles may transmit audio, video, and/or other data to the display 755. For example, as described above, a first half of the display's 755 screen may show video transmitted by the first gaming console 620 while a second half of the display's 755 screen may show video transmitted by the second gaming console 622.

It should be appreciated that there may be more than one display coupled with the gaming consoles. For example, a second display may show a different spectator view than a spectator view shown by a first display. Alternatively, each display may show a private view of each gaming console. It should be appreciated that embodiments discussed below with respect to the following figures may also include multiple displays in the same way.

The gaming consoles may communicate with each other, for example, through the network 665. However, the gaming consoles may be communicatively coupled directly with one another, for example through a wireless or wired interface. As a result, the gaming consoles may cooperate with one another to support multiplayer games. For example, a game being executed on the gaming console 620 may communicate with another instance of the same game being executed on the gaming console 622 to provide a multiplayer gaming experience.

In various embodiments, the gaming consoles 620 and 622 may provide private views on their respective displays 650 and 652 while providing a spectator view on the display 755. The private views may be shown only on each respective display to help prevent other users or players of a multiplayer game being played on the consoles from seeing other players' views. In this way, a player's view will be private and prevent others from anticipating future actions from the player, learn information about the player (e.g., health statistics, available weaponry, etc), learn about a location of the player (e.g., a location in the map or level), and so on. In addition, players will be less distracted by other players' views, providing a more realistic gaming experience.

The spectator view shown on the display 755 may include a general view of the game that the players of the game or others may view. For example, in a football game, the spectator view may show angles similar to those shown when watching a televised football game, thereby providing a more realistic experience to viewers of the display 755. Alternatively, the spectator view may choose to follow different players of the game at random, either revealing their private view or other views (e.g., a bird's eye view of a player's character instead of the character's personal view). Or, the display 755 may show statistics related to the game play. For example, player rankings, remaining game time, and so on.

It should be appreciated that the gaming consoles may cooperate with each other to provide a multiplayer gaming experience without the display 755. For example, the gaming consoles 620 and 622 may provide a private view on their respective displays 650 and 652 so that players of a game may benefit from the advantages discussed above. However, a spectator view may not be necessary or preferable. In fact, the gaming consoles 620 and 622 may provide the multiplayer gaming experience without the existence of an additional display like the display 755.

It should be borne in mind that the gaming consoles may execute different games. Further, it should be appreciated that the gaming consoles may both transmit information to the display 755 even while playing different games. For example, a portion of the display 755 may show the game being played on the gaming console 620 and a portion of the display 755 may show the game being played on the gaming console 622. For example, a portion of the display 755 may show list of other display's portions, with device identifiers, user names, game names, etc.

The video, audio, and/or other data transmitted from the gaming consoles to the display 755 may or may not be compressed before sending, and decompressed and/or decoded when received by the display 755. For example, see copending U.S. patent application Ser. No. 13/727,357, “VIRTUALIZED GRAPHICS PROCESSING FOR REMOTE DISPLAY,” filed Dec. 26, 2012, which is incorporated herein by reference for all purposes. For example, the gaming console 620 may compress the data into H.264 format for transmittal to the display 755. Once the display 755 receives the data to be displayed, it may decompress and display the video, audio, and/or other data. It should be noted that in all embodiments of the invention, the file formats used are not limited to H.264 and that the communication protocols may be but are not limited to IEEE 802.11 protocols, but for example, Bluetooth.

It should be noted that a communication interface component 125, as discussed with respect to FIG. 7B below, may be coupled with the display 755. The communication interface component 125 of FIG. 7B may be the same as or similar to the video arrangement device 400 of FIGS. 4-6B. As a result, even though the gaming consoles may communicate with the display 755 through the network 665, the display 755 may be coupled with the network 665 through the communication interface component 125. In other words, the communication interface component 125 may be operable to allow the display 755 to communicate through the network 665.

FIG. 7B is a block diagram 701 of a handheld gaming console 620 communicatively coupled with a display 755, according to embodiments of the present invention. FIG. 7B includes a communication interface component 125 that is operable to allow the gaming console 620 to communicate with the display 755 without a network.

The communication interface component 125 may be, for example, a cable set-top box operable to provide video and audio from the handheld gaming console 620 to the display 755. The communication interface component 125 may be, for example, a dongle with an HDMI port that is operable to connect with the display's 755 HDMI port. It should be appreciated that the interface component 125 may support other interfaces that are operable to provide video, audio, and/or data. For example, a DVI or a DisplayPort connection. The interface component 125 may also be operable to wirelessly communicate with the gaming console 620. As a result, the gaming console may transmit video, audio, and/or data to the interface component 125, which in turn may provide such information to the display 755. Ultimately, the video, audio, and/or other data sent by the gaming console 620 may be displayed or played by the display 755 similarly to the embodiments discussed with respect to FIG. 7A.

It should be appreciated that multiple gaming consoles may transmit data to the interface component 125, in other words, the interface component 125 may be operable to communicate with more than one gaming console. As a result, various embodiments involving more than one gaming console, like those discussed with respect to FIG. 7A, are possible with the use of the interface component 125 and without a network. It should also be noted that multiple gaming consoles may communicate with one another through the interface component 125.

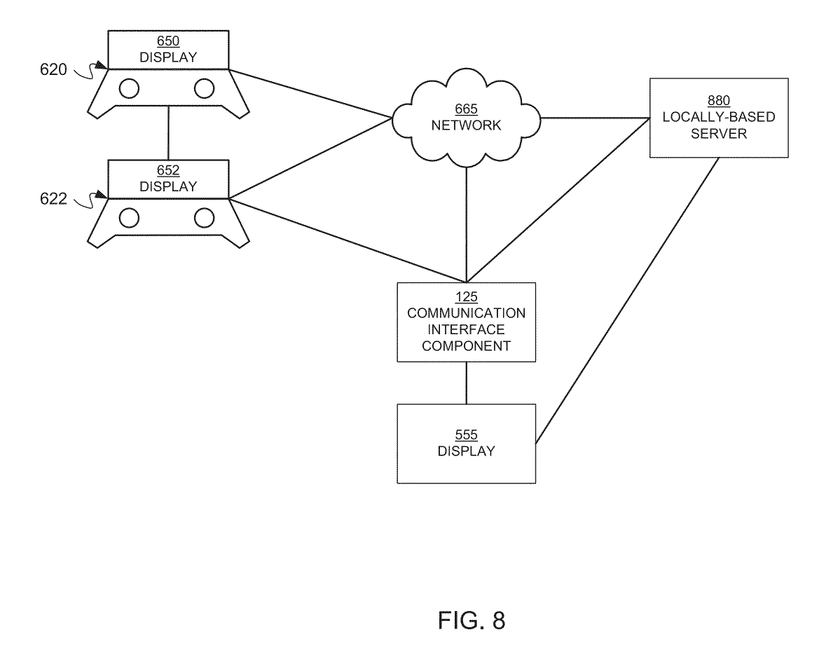

FIG. 8 is a block diagram of one or more handheld gaming consoles 620 and 622 communicatively coupled with a locally-based server 880, according to embodiments of the present invention. The handheld gaming console 620 of FIG. 8 may be the same as or similar to the handheld gaming console 620 of FIGS. 5A-7B. For example, the gaming console 620 may include a display 650 similar to the console display 650 of FIG. 5A.

The gaming console 620 may be communicatively coupled with the locally-based server 880 through a network 665, for example, through wired or wireless interfaces. The network 665 may be similar to the network 350 of FIG. 3 and may be, for example, a local area network (LAN).

The locally-based server 880 may be a computer system that is located proximately to the gaming console 620. For example, the locally-based server 880 may be located in the same house or building as the gaming console 620, or connected with the gaming console 620 primarily through a LAN. In other words, the locally-based server 880 could be a household personal desktop computer.

In one example, the locally-based server 880 may execute a software application requiring graphics and audio processing. The locally-based server 880 may then transmit the graphics and audio to the gaming console 620 for display and play back.

The video, audio, and/or other data transmitted from the locally-based server 880 may or may not be compressed before sending, and decompressed and/or decoded when received by the gaming console 620. For example, see copending U.S. patent application Ser. No. 13/727,357, “VIRTUALIZED GRAPHICS PROCESSING FOR REMOTE DISPLAY,” filed Dec. 26, 2012, which is incorporated herein by reference for all purposes. For example, the locally-based server 880 may compress the data into H.264 format for transmittal to the gaming console 620. Once the gaming console 620 receives the data to be displayed, it may decompress and display the video, audio, and/or other data.

The gaming console 620 may be operable to send user inputs to the locally-based server 880. For example, the gaming console 620 may send data representing user interaction with the physical controls, touchscreen, internal/external motion tracking components, and so on, to the locally-based server 880. In this way, a user may control software applications or content that is being executed on the locally-based server 880. The gaming console 620 may send user inputs through the network 665.

The locally-based server 880 may still provide generated video and audio related to an application to the gaming console 620. Alternatively, the locally-based server 880 may play back media that requires stronger processing than the gaming console 620 is able to provide. For example, the locally-based server 880 may decode a high-resolution movie that is unable to be processed by the gaming console 620 by itself, and then send video and audio related to the movie to the gaming console 620 for display.

The various embodiments discussed with respect to other figures may be used with the locally-based server 880. For example, there may be more than one gaming console, e.g., FIG. 8 also includes the second gaming console 622.

The locally-based server 880 may provide content to the second gaming console 622 simultaneously with gaming console 620. The content provided to multiple gaming consoles may be related or unrelated to each other. For example, the locally-based server 880 may provide a movie to the gaming console 620 and provide video and graphics for a video game to the second gaming console 622. Alternatively, the locally-based server 880 may provide related content to more than one gaming console. For example, the locally-based server 880 may provide different video and audio to the gaming consoles 620 and 622 for different characters within a multiplayer video game environment.

FIG. 8 includes the display 555 that may be coupled with the locally-based server 880 and multiple gaming consoles 620 and 622 through the network 665 or directly through a communication interface component. The gaming consoles 620 and 622 may continue to display video and play back audio sent by the locally-based server 880, while the display 555 displays a spectator view sent by the locally-based server 880. In one or more embodiments, the communication interface component receives video from the gaming consoles 620 and 622 and the locally-based server 880 and arranges and combines the various video content into a single video. Alternatively, the gaming consoles 620 and 622 may act as controllers while the display 555 displays the main content, optionally with the gaming consoles 620 and 622 game-related information like statistics sent by the locally-based server 880. The locally-based server 880 may communicate with the display through the network 665 or directly through a communication interface component or through a direct wired connection (e.g. DVI, HDMI, etc.).

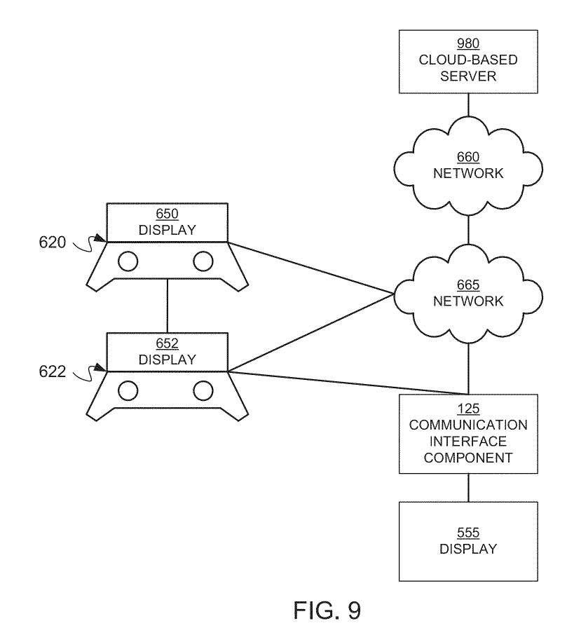

FIG. 9 is a block diagram of a handheld gaming console 620 communicatively coupled with a cloud-based server 980, according to embodiments of the present invention. The handheld gaming console 620 of FIG. 9 may be the same as or similar to the handheld gaming console 620 of FIGS. 5A-7B. For example, the gaming console 620 may include a display 650 similar to the console display 650 of FIG. 5A.

The gaming console 620 may be communicatively coupled with the cloud-based server 980 through a network 660 and/or 665, for example, through wired or wireless interfaces. The networks 660 and 665 may be similar to the network 350 of FIG. 3. For example, the network 660 may be wide area network (WAN) while the network 665 is a local area network (LAN).

The cloud-based server 980 may be part of a cloud-based computing system. Cloud computing is the use of computing resources (hardware and software) that are delivered as a service over a network (typically the Internet). Therefore, the cloud-based server 980 may be remotely located from the gaming console 620. For example, the cloud-based server 980 may be located in a separate building or city as the gaming console 620.

In one example, the cloud-based server 980 may execute a software application requiring graphics and audio processing. The cloud-based server 980 may then transmit the graphics and audio to the gaming console 620 for display and play back.

The video, audio, and/or other data transmitted from the cloud-based server 980 may or may not be compressed before sending, and decompressed and/or decoded when received by the gaming console 620. For example, see copending U.S. patent application Ser. No. 13/727,357, “VIRTUALIZED GRAPHICS PROCESSING FOR REMOTE DISPLAY,” filed Dec. 26, 2012, which is incorporated herein by reference for all purposes. For example, the cloud-based server 980 may compress the video data into H.264 format for transmittal to the gaming console 620. Once the gaming console 620 receives the data to be displayed, it may decompress and display the video. Similar processing may be applied to audio or other data.

The gaming console 620 may be operable to send user inputs to the cloud-based server 980. For example, the gaming console 620 may send data representing user interaction with the physical controls, touchscreen, internal/external motion tracking components, and so on, to the cloud-based server 980. In this way, a user may control software applications or content that is being executed on the cloud-based server 980. The gaming console 620 may send user inputs through the networks 660 and 665.

Because the cloud-based server 980 may be remotely communicatively coupled with the gaming console 620, the gaming console 620 may be able to receive data from the cloud-based server 980 while at different locations. For example, the gaming console 620 may be able to receive data from the cloud-based server 980 while at different homes, outdoors, or even while located in different countries. Accordingly, a user of the gaming console 620 may be free to travel between different locations and continue to benefit from the services of the cloud-based server 980.

The cloud-based server 980 may provide generated video and audio related to the application to the gaming console 620. Alternatively, the cloud-based server 980 may play back media that requires stronger processing than the gaming console 620 is able to provide. For example, the cloud-based server 980 may decode a high-resolution movie that is unable to be processed by the gaming console 620 by itself, and then send video and audio related to the movie to the gaming console 620 for display.

The various embodiments discussed with respect to other figures may be used with the cloud-based server 980. For example, there may be more than one gaming console, e.g., FIG. 9 also includes the second gaming console 622.

The cloud-based server 980 may provide content to the second gaming console 622 simultaneously with gaming console 620. The content provided to multiple gaming consoles may be related or unrelated to each other. For example, the cloud-based server 980 may provide a movie to the gaming console 620 and provide video and graphics for a video game to the second gaming console 622. Alternatively, the cloud-based server 980 may provide related content to more than one gaming console. For example, the cloud-based server 980 may provide different video and audio to the gaming consoles 620 and 622 for different characters within a multiplayer video game environment.

FIG. 9 includes the display 555 that may be coupled with the cloud-based server 980 and multiple gaming consoles 620 and 622 through the network 665 or directly through the communication interface component 125. The gaming consoles 620 and 622 may continue to display video and play back audio sent by the cloud-based server 980, while the display 555 displays a spectator view sent by the cloud-based server 980. In one or more embodiments, the communication interface component receives 125 video from the gaming consoles 620 and 622 and the cloud-based server 980 and arranges the various video content into a single video. Alternatively, the gaming consoles 620 and 622 may act as controllers while the display 555 displays the main content, optionally with the gaming consoles 620 and 622 game-related information like statistics sent by the cloud-based server 980. The cloud-based server 980 may communicate with the display through the network 665 or directly through the communication interface component 125.

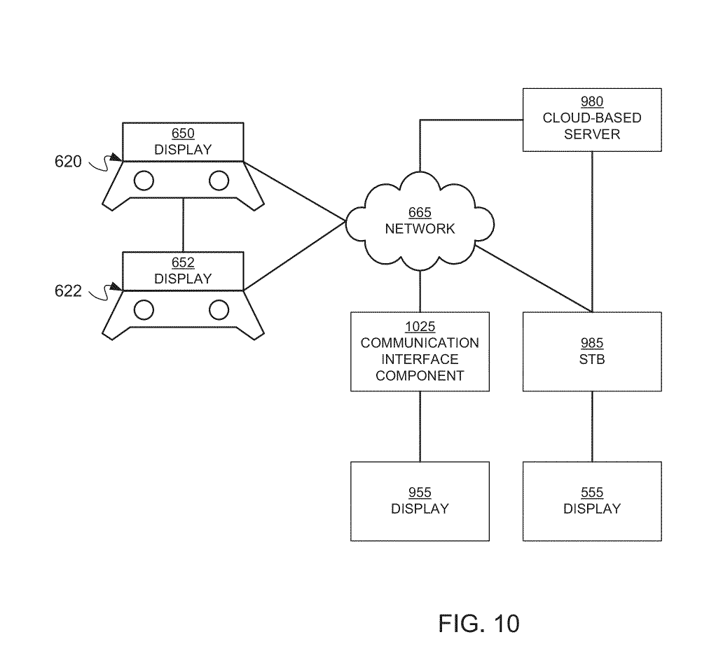

FIG. 10 is a block diagram of the handheld gaming console 620 communicatively coupled with the cloud-based server 980 that is in turn communicatively coupled with a set-top box 985, according to embodiments of the present invention. The handheld gaming console 620 of FIG. 10 may be the same as or similar to the handheld gaming console 620 of FIGS. 5A-7B. For example, the gaming console 620 may include a display 650 similar to the console display 650 of FIG. 5A.

Similar to FIG. 9, the gaming console 620 may be communicatively coupled with the cloud-based server 980 through a network, for example, through the network 665. As discussed with respect to FIG. 9, the cloud-based server 980 may be part of a cloud-based computing system. Therefore, the cloud-based server 980 may be remotely located from the gaming console 620.

FIG. 10 also includes a set-top box (STB) 985 communicatively coupled with the cloud-based server 980. The STB 985 may be a device that may contain a tuner and connects to a television set and an external source of signal, turning the source signal into content in a form that can then be displayed on the television screen or other display device. For example, the STB 985 may be used to provide content from cable or satellite television sources to a television. For example, the STB 985 may be located inside a house or a hotel room and connected to a television, e.g., the display 555.

The STB 985 may receive data from the cloud-based server 980 related to or representing gaming or multimedia content. For example, the cloud-based server 980 may send video, audio, and/or other data through cable or satellite distribution paths to the STB 985. In another example, the cloud-based server 980 may send video, audio, and/or other data through the network 665 to the STB 985 when the STB 985 is coupled with the network 665.

The cloud-based server 980 may send video and audio to the STB 985 through a specific channel that the STB 985 may be operable to tune into. For example, when the STB 985 tunes into channel X, channel X may provide the video and audio representing the content processed by the cloud-based server 980. The STB 985 may send the content to the display 555 for display.

In one example, the cloud-based server 980 may execute a software application requiring graphics and audio processing. The cloud-based server 980 may then transmit the graphics and audio to the STB 985 through a certain channel for display and play back ultimately on the display 555. Accordingly, the STB 985 may provide the content with the aid of the cloud-based server 980 that the gaming console 620 may not have otherwise been able to provide. Even if the gaming console 620 may have been able to provide the same content, it may be able to do so at a lower quality or with limitations, but the cloud-based server 980 may be capable of providing higher quality and limitation free content generation.

The gaming console 620 may be operable to send user inputs to the cloud-based server 980. For example, the gaming console 620 may send data representing user interaction with the physical controls, touchscreen, internal/external motion tracking components, and so on, to the cloud-based server 980. In this way, a user may control software applications or content that is being executed on the cloud-based server 980. The gaming console 620 may send user inputs through the network 665. As a result, the video and audio representing the content may be displayed through the STB 985 but controlled through the gaming console 620.

The cloud-based server 980 may provide generated video and audio related to the application to the STB 985. Alternatively, the cloud-based server 980 may play back media that requires stronger processing than the gaming console 620 is able to provide. For example, the cloud-based server 980 may decode a high-resolution movie that is unable to be processed by the gaming console 620 by itself, and then send video and audio related to the movie to the STB 985 for display.

The various embodiments discussed with respect to other figures may be used with the cloud-based server 980 and STB 985. For example, there may be more than one gaming console, e.g., FIG. 10 also includes the second gaming console 622.

The cloud-based server 980 may provide content to the second gaming console 622 simultaneously with gaming console 620. The content provided to multiple gaming consoles may be related or unrelated to each other. For example, the cloud-based server 980 may provide a movie to the STB 985 and provide video and graphics for a video game to the gaming consoles 620 and 622. Alternatively, the cloud-based server 980 may provide related content to more than one gaming console. For example, the cloud-based server 980 may provide private or statistics views to the gaming consoles 620 and 622 and a spectator view to the STB 985.

FIG. 10 includes a communication interface component 1025 coupled with the cloud-based server 980 and a display 955. In some embodiments, display 955 may be similar to or the same as the display 555. The communication interface component 1025 may be similar to the communication interface component 125 of FIG. 7B and may be coupled with the cloud-based server 980 through the network 665. For example, the communication interface component 1025 may be a dongle with an HDMI port that is operable to connect with the display's 955 HDMI port. The communication interface component 1025 may not process the software application or content, but may instead be operable to provide the video and audio processed by the cloud-based server 980 to the display 555. In other words, while the communication interface component 1025 may not be a traditional STB, it may provide similar functionality as the STB 985 for channeling content processed and sent from the cloud-based server 980.

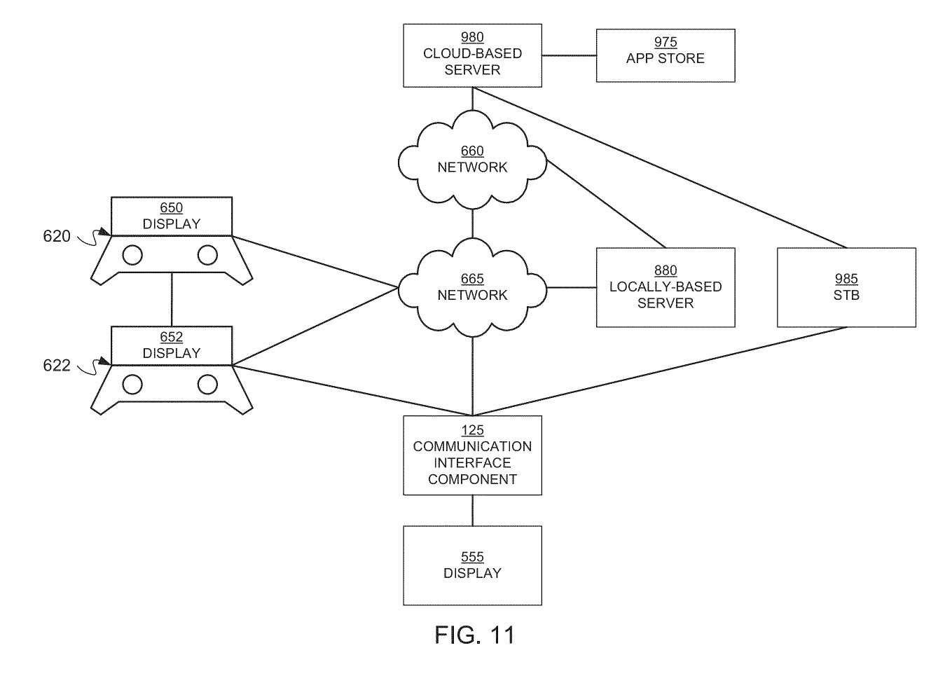

FIG. 11 is a block diagram of a handheld gaming console 620 communicatively coupled with the external display 555, app store 975, locally-based server 880, cloud-based server 980, STB 985, according to embodiments of the present invention. The configuration of FIG. 11 may include more or less elements or components, for example, a second handheld gaming console 622, a second locally-based server, or the absence of the cloud-based server 980. Accordingly, multiple configurations may be possible.

The handheld gaming console 620, optionally in conjunction with the locally-based server 880, cloud-based server 980, and/or the communication interface component 125, may automatically or dynamically determine the configuration of the system. For example, one or more components may determine that and instruct the locally-based server 880 to execute a software application and send the software application content to the handheld gaming console 620 and/or the display 555, e.g., like discussed with relation to FIG. 8. Alternatively, one or more components may determine that and instruct more than one handheld gaming consoles to execute a game downloaded from the app store 975, like discussed with relation to FIG. 7A.

The determination of the configuration may be based on the software application(s) executed. For example, a software application downloaded from the app store 975 may include with or separately from the software application instructions related to the configuration of the software application. Accordingly, the configuration may be dependent on, for example, a specific game or user profile.

It should be appreciated that while embodiments of the invention are often discussed with respect to one or more networks, such networks may or may not include devices additional to those shown in the figures. For example, a network may include one or more routers, switches, hubs, and so on. Alternatively, an illustrated network may simply symbolize a communicative coupling between devices. For example, in FIG. 8, the network 665 may symbolize the connection between the gaming console 620 and the locally-based server 880. The gaming console 620 may be directly connected with the locally-based server 880 through the communication interface of each device, e.g., without the use of a wireless router.

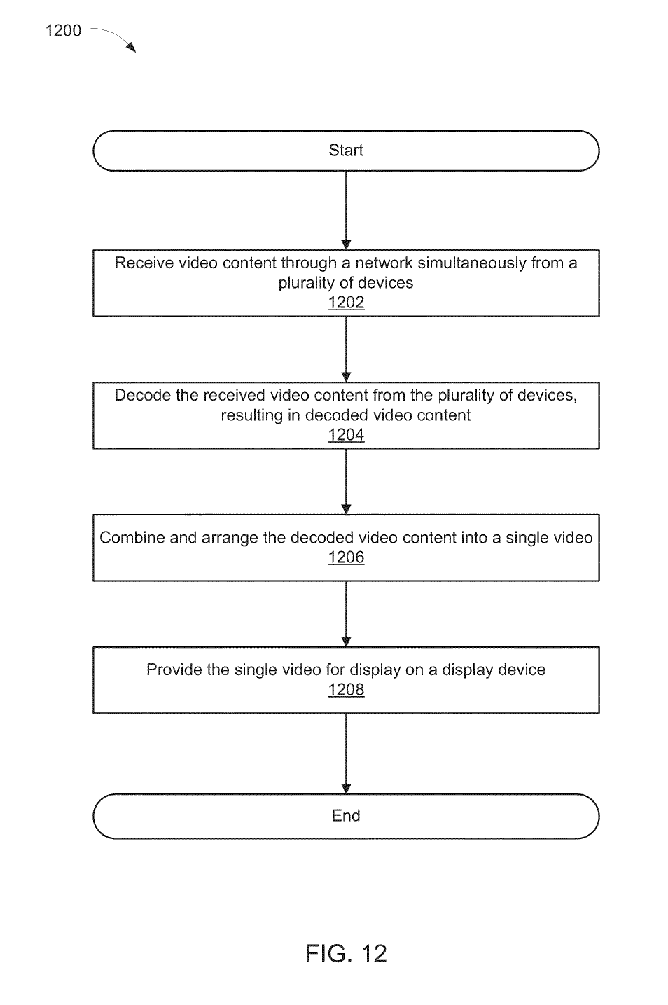

FIG. 12 shows a flowchart 1200 of an exemplary computer-implemented process of simultaneously displaying video content. While the various steps in this flowchart are presented and described sequentially, one of ordinary skill will appreciate that some or all of the steps can be executed in different orders and some or all of the steps can be executed in parallel. Further, in one or more embodiments of the invention, one or more of the steps described below can be omitted, repeated, and/or performed in a different order. Accordingly, the specific arrangement of steps shown in FIG. 12 should not be construed as limiting the scope of the invention. Rather, it will be apparent to persons skilled in the relevant art(s) from the teachings provided herein, that other functional flows are within the scope and spirit of the present invention. The flowchart 1200 of FIG. 12 may be described with continued reference to exemplary embodiments described above, though the method is not limited to those embodiments.

In block 1202, video content is received through a network simultaneously from a plurality of devices. In some embodiments, the video content may include content associated with a multiplayer game. For example, in FIG. 5A, the video arrangement device receives video content from a plurality of devices through the network. The video arrangement device may receive the video content from the plurality of devices simultaneously.

In block 1204, the received video content is decoded. For example, in FIG. 5A, the video arrangement device may decode the received video content from the plurality of devices. The video content may be encoded using any standard related to audio and/or video decoding.

In block 1206, the decoded video content is combined and arranged into a single video. For example, in FIG. 4, the arranging module combines and arranges the received video content from the plurality of devices into a single video. The combining and arranging of the video content may be done in any manner suitable for displaying a single video on a display device.

In some embodiments, the combining and arranging may be done where the video content received from each of the plurality of devices is equally-sized within the single video. Each of the equally-sized areas within the single video may be associated with one of each of the plurality of the devices.

In block 1208, the single video is provided for display on a display device. For example, in FIG. 5A, the video arrangement device displays the single video on the display device in a split-screen side-by-side format. In some embodiments, the single video may only include a subset of the received video content, e.g., a map or spectator view of a multiplayer game.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered as examples because many other architectures can be implemented to achieve the same functionality.

The process parameters and sequence of steps described and/or illustrated herein are given by way of example only. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

While various embodiments have been described and/or illustrated herein in the context of fully functional computing systems, one or more of these example embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. These software modules may configure a computing system to perform one or more of the example embodiments disclosed herein. One or more of the software modules disclosed herein may be implemented in a cloud computing environment. Cloud computing environments may provide various services and applications via the Internet. These cloud-based services (e.g., software as a service, platform as a service, infrastructure as a service, etc.) may be accessible through a Web browser or other remote interface. Various functions described herein may be provided through a remote desktop environment or any other cloud-based computing environment.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as may be suited to the particular use contemplated.

Embodiments according to the invention are thus described. While the present disclosure has been described in particular embodiments, it should be appreciated that the invention should not be construed as limited by such embodiments, but rather construed according to the below claims.

What is claimed is:

1. An apparatus comprising:
a receiving module operable to receive video content through a communication network simultaneously from a plurality of devices;
a decoding module operable to decode the received video content from the plurality of devices into decoded video content;
an arranging module operable to combine and arrange the decoded video content into a single video; and
a displaying module operable to provide the single video for display on a display device.

2. The apparatus of claim 1, wherein the arranging module is further operable to combine and arrange the video content received from the plurality of devices within a plurality of equally-sized areas within the single video.

3. The apparatus of claim 2, wherein each of the equally-sized areas within the single video is associated with the received video content from a respective device of the plurality of devices.

4. The apparatus of claim 1, wherein the displaying module is further operable to simultaneously display a subset of the video content within the display, wherein a position, within the display, of the subset of the video content is switchable.

5. The apparatus of claim 1, wherein the video content comprises content associated with multiple views of a software application.

6. The apparatus of claim 5, wherein the content associated with the software application comprises at least one of a scoreboard, a map, or a spectator view of the software application.

7. The apparatus of claim 1, further comprising an application module operable to provide an application programming interface (API); and
wherein the video content is based at least in part on programmable parameters of the API.

8. A method comprising:
receiving video content through a communication network simultaneously from a plurality of devices;
decoding the received video content from the plurality of devices into decoded video content;
combining and arranging the decoded video content into a single video; and
providing the single video for display on a display device.

9. The method of claim 8, wherein the combining and arranging further comprises combining and arranging the video content received from the plurality of devices within a plurality of equally-sized areas within the single video.

10. The method of claim 9, wherein each of the equally-sized areas within the single video is associated with the received video content from a respective device of the plurality of devices.

11. The method of claim 8, wherein the displaying further comprises simultaneously displaying a subset of the video content within the display, wherein a position, within the display, of the subset of the video content is switchable.

12. The method of claim 8, wherein the video content comprises content associated with multiple views of a software application.

13. The method of claim 12, wherein the content associated with the software application comprises at least one of a scoreboard, a map or a spectator view of the software application.

14. The method of claim 8, further comprising basing video content at least in part on programmable parameters of an application programming interface.

15. A non-transitory computer readable medium comprising a plurality of instructions configured to execute on at least one computer processor to enable the computer processor to:
receive video content through a network simultaneously from a plurality of devices;
decode the received video content from the plurality of devices into decoded video content;
combine and arranging the decoded video content into a single video; and
provide the single video for display on a display device.

16. The non-transitory computer-readable storage medium of claim 15, wherein combining and arranging further comprises combining and arranging the video content received from the plurality of devices within a plurality of equally-sized areas within the single video.

17. The non-transitory computer-readable storage medium of claim 16, wherein each of the equally-sized areas within the single video is associated with the received video content from respective devices of the plurality of devices.

18. The non-transitory computer-readable storage medium of claim 15, wherein the video content comprises content associated multiple views of with a software application.

19. The non-transitory computer-readable storage medium of claim 18, wherein the content associated with the software application comprises at least one of a scoreboard, a map, or a spectator view of the software application.

20. The non-transitory computer-readable storage medium of claim 15, wherein the plurality of instructions further comprise functionality to base video content at least in part on programmable parameters of an application programming interface.
